(19) United States
(12) Patent Application Publication
(10) Pub. No.: US 2015/0208685 A1
(43) Pub. Date: Jul. 30, 2015

(54) Use of Solid Fat To Modulate Texture Of Low-Fat Emulsions

(71) Applicant: KRAFT FOOD GROUP BRANDS LLC, Northfield, IL (US)

(72) Inventors: William H. Schwimmer, Evanston, IL (US); Dennis Ann Kim, Palatine, IL (US); Robert F. Class, Winthrop Harbor, IL (US); Yan Wang, Northfield, IL (US); Shamsheer Mahammad, Wheeling, IL (US); Bruce E. Campbell, Glenview, IL (US); Johnny Casasnovas, Northfield, IL (US)

(21) Appl. No.: 14/430,051

(22) PCT Filed: Sep. 20, 2013
(86) PCT No.: PCT/US2013/061007

§ 371 Date: Mar. 20, 2015

Related U.S. Application Data
(60) Provisional application No. 61/704,276, filed on Sep. 21, 2012.

(51) Int. Cl. A23D 7/015

(52) U.S. Cl. CPC A23D 7/015

(57) ABSTRACT

Spoonable, pourable, and/or spreadable dressings or edible continuous aqueous emulsions are provided that include a fat blend that is a specific balance of a solid fat portion or solid fat fraction (which may or may not be pre-crystallized) and a liquid fat portion in effective relative amounts, such that when the fat blend is added to dressings and edible continuous aqueous emulsions, lower fat versions effectively mimic the sensory, texture, viscosity, storage modulus, and/or yield stress of much higher fat dressings or emulsions.

### CROSS REFERENCE TO RELATED APPLICATIONS

This application claims the benefit of U.S. Provisional Application No. 61/704,276, filed Sep. 21, 2012, which is incorporated by reference herein in its entirety.

### FIELD

Spoonable, pourable, and/or spreadable dressings, and in particular, lower fat edible, continuous aqueous compositions having organoleptic characteristics of a higher fat product.

### BACKGROUND

Textures of conventional dressings, such as spoonable or spreadable dressings (i.e., mayonnaise-type dressings) or pourable dressings (i.e., salad-type dressings) are typically an oil in water emulsion that is structured through a combination of emulsified, liquid vegetable oil and a variety of starches, gums, and hydrocolloids that build viscosity in the continuous phase of the dressing. When formulating lower fat versions of such dressings, it is difficult to match the textural qualities of the higher fat products without greater levels of the continuous-phase-structuring ingredients (e.g., starches, gums, hydrocolloids, and the like) to build viscosity and yield stress at lower fat levels. However, with increased levels of starches and hydrocolloids, there was also a tendency to produce undesirable attributes such as, but not limited to, uneven textures, starchy mouthfeel, paste-like mouthfeel, stickiness, and/or stringiness in the lower fat products. Due to these undesired attributes, lower fat products are often produced with less texture or yield stress than the higher fat counterparts. This produces a textural or rheological gap between a light or lower fat product and the higher fat counterparts. This gap in product characteristics can, in some cases, be perceived by consumers and may be one reason why lower fat or light dressings are not readily accepted as equivalent to full fat products.

### SUMMARY

In one aspect of this disclosure, a fat or fat blend configured for spoonable, pourable, and/or spreadable compositions that is effective to close the textural or rheological gap between full fat and comparable lower fat products. In one approach of this aspect, spoonable, pourable, and/or spreadable dressings or edible continuous aqueous emulsions are provided that include a fat blend that is a specific balance of a solid fat portion or solid fat fraction (which may or may not be pre-crystallized) and a liquid fat portion in effective relative amounts, such that when the fat blend is added to dressings and edible continuous aqueous emulsions, lower fat versions effectively mimic the sensory, texture, viscosity, storage modulus, and/or yield stress of much higher fat dressings or emulsions. To this end, the solid fat portion may have a unique solid fat content and the overall solid fat and oil blend may have a specific solid fat content and unique fatty acid profile to achieve such functionalities.

In sonic approaches, for example, use of the unique fat blends herein permit a light spoonable or spreadable dressing or emulsion having about 5 percent total fat to mimic the sensory, texture, viscosity, yield stress, and/or storage modulus of a substantially similar composition but with about 9 percent total fat. In other exemplary approaches, use of the fat blends herein permits a light spoonable or spreadable dressing or emulsion having about 9 percent total fat to mimic a substantially similar product but with about 22 percent total fat. In yet other exemplary approaches., use of the fat blends herein permit a pourable dressing or composition having about 13 percent total fat to mimic a substantially similar pourable dressing or composition having about 38 percent total fat. Thus, use of the unique fat blends herein permit a reduction of about 44 to about 65 percent in total fat, but such reduced fat dressings still exhibit the sensory, texture, viscosity, yield stress, and/or storage modulus of their fuller fat counterparts. In some approaches, this is also achieved with reduced or even little to no use of the gums, starches or excess starches, and other hydrocolloids that previously were needed to build desired texture in lower fat products. The fat blends herein, in some approaches, are unique because, among other features, it may form segregated fat crystals in the dressings or compositions that are separate from or separated apart from liquid oil droplets in the composition or emulsion, which is compositionally unexpected in an emulsion or continuous aqueous emulsion.

In another aspect of the disclosure, the solid fat is prepared by crystalizing the fat in situ or, in other words, after being blended with other fats and compositional ingredients. In one approach, the solid fat is first melted, then incorporated directly with other dressing components or blended with the liquid oil. Thereafter, the solid fat crystallizes into a size and/or shape, in some cases, separate from the liquid oil, effective to help (along with the other features discussed herein) close the rheological gap discussed above. In another aspect of this disclosure, a solid fat fraction is provided having preformed or a pre-crystallized solid fat portion and, in some cases, a specific solid fat content providing a unique melting profile that is effective to allow lower fat products to mimic the textural and yield stress attributes of much higher fat spoonable, pourable, and/or spreadable dressings. In some approaches, the pre-crystallized solid fat portion is effective to substantially retain a crystal size throughout processing into the final product.

### BRIEF DESCRIPTION OF THE DRAWINGS

The various non-limiting embodiments described herein may be better understood by considering the following description in conjunction with the accompanying drawing sheets.

FIGS. 1 and 2 include graphs plotting viscosity (Pas) and shear rate of compositions according to various embodiments described herein.

FIG. 3 includes a graph plotting strain (%) and time (s) of compositions according to various embodiments described herein.

FIGS. 4 and 5 include images of solid fat fractions including crystals of thereof according to various embodiments described herein.

FIG. 6 includes a graph plotting viscosity (GPas) and shear rate (1/s) of a pourable compositions according to various embodiments described herein.

FIGS. 7a-b and 8a-b include images of solid fat fractions including crystals.

FIG. 9 includes a graph plotting storage modulus (Pa) and temperature (° C.) of solid fat fractions.

FIG. 10 includes a graph plotting solid fat content: (SFC, %) and temperature (° C.) according to various embodiments described herein.

FIG. 11 includes a graph of firmness (Pa) V. time (s) and temperature (° C.) v. time (s) according to various embodiments described herein.

FIG. 12 includes a graph plotting storage modulus (Pa) and temperature (° C.) and relaxation time (s) v. temperature (° C.) according to various embodiments described herein.

FIGS. 13-15 include sensory profiles of compositions according to various embodiments described herein.

FIGS. 16a-b and 17a-b include images of solid fat fractions including crystals according to various embodiments described herein.

FIG. 18 includes a flow diagram for making solid fat fractions according to various embodiments described herein.

The reader will appreciate the foregoing details, as well as others, upon considering the following description of various non-limiting and non-exhaustive embodiments according to the present disclosure.

### DETAILED DESCRIPTION

The present disclosure provides a novel blended fat and edible compositions thereof that can close the textural or rheological gap between full fat and lower fat spoonable, pourable, and/or spreadable dressings or compositions. In one approach, the fat blends are particularly configured to he effective for closing this textural or rheological gap in edible continuous emulsions or compositions. This new fat blend and edible compositions thereof are unique because they permit a lower fat product to mimic the sensory, textural, viscosity, yield stress, and/or storage modulus of higher fat products at relatively lower fat usage levels in the product or composition. In some approaches, the desired fat blends configured for rheological gap closure in the context of spoonable, pourable, and spreadable dressing or compositions are mixtures of select solid fat portions or fractions combined with a liquid oil portion. As shown more herein, use of individual fats or oils or not using the discovered ratios of fats and oil do not achieve the unique textural and sensory characteristics in lower fat continuous aqueous emulsions or compositions.

As referred to herein, a lower fat spoonable dressing or composition generally has less than about 20 percent total fat and, in other approaches, about 5 to about 15 percent total fat. Regarding pourable dressings, lower fat generally means less than about 20 percent total fat, and in other approaches, about 5 to about 15 percent total fat. These lower fat compositions generally exhibit the texture and flavor of their fuller fat counterparts.

In various embodiments, the fat blends or factions may generally comprise a mixture of one or more solid fat portions or solid fat fractions combined with a liquid oil portion. By one approach, the solid fat fraction may be any solid fat or blends of solid fats with the appropriate solid fat content and/or fatty acid profile. In some approaches, the solid fat portion may include a mixture of at least two palm-based fats (i.e., a first palm-based fat and a second, different palm-based fat). As used herein, a palm-based fat is, in some approaches, a fat obtained primarily from the pulp or mesocarp of the fruit portion of oil palms. In some approaches, the first palm-based fat has a solid fat content greater than the second palm-based fat at both about 25° C. and at about 40° C. To achieve the unique functionalities set forth in this disclosure in the context of edible continuous aqueous emulsions and compositions (i.e., such as salad-type dressing) and when two or more palm fats or fractions are utilized, the fat fractions or blends have, in some approaches, include a palm ratio of the first palm-based fat to the second or more palm-based fat, by weight, from about 0.5 to about 0.7.

In other approaches, the solid fat portion of the fat blend may include or also be based on a number of different fat types, and in one approach, may be based on or include palm, coconut, shea butter, diglycerides (like distearate), illipe, kokum, mango kernel, sal, and the like fats. In some approaches, the solid fat portion may be a blend of one or more fat types. In one approach, the fat portion is based on a selection of two or more palm based fats combined with a select amount of soybean oil. For example, the solid fat fraction may be a blend of palm and other fats ranging from a 75:25 blend to a 10:90 blend of palm to other fats. The blend of palm-based fats may comprise the first palm-based fat, second palm-based fat, and (in some optional approaches) at least one additional palm-based fat or other fat. The blend of palm-based fats may comprise the first palm-based fat, second palm-based fat, and a third optional palm-based fat.

The overall fat blend is also combined with a liquid oil portion. In some approaches, the liquid oil portion is soybean oil, canola oil, and the like. The fat blends herein also have a specific fat-to-oil ratio in the context of edible continuous aqueous emulsions and compositions to achieve the desired functionalities and close the rheological gap noted above. By some approaches, the fat-to-oil ratio is a ratio of the blend of solid fat (such as palm-based fats) to liquid oil (such as soybean oil), by weight, from about 0.1 to about 3.0. It has been discovered that such combination of palm ratio (when two or more palm fats are used) and the fat-to-oil ratio, when combined with the other features of this disclosure, uniquely achieves the combined sensory and textural characteristics in the compositions to close the so-called rheological gap between low fat and full fat dressings and compositions described previously. In general, deviation from the blends and ratios set forth herein compromise one or more of the desired textural and/or sensory qualities of resultant product.

Turning to more of the specifics and in the exemplary approach when two or more palm fats are utilized, the solid fat portion and compositions thereof include select ratios of the one palm fat to the other palm fat in the blend, which is called the palm ratio. In various embodiments, the palm ratio of the first palm-based fat to the second palm-based fat (or blend of palm-based fats), by weight, may be from 0.5 to 0.9, 0.5 to 0.85, greater than 0.5 to less than 0.85, 0.5 to 0.7, 0.5 to 0.75, 0.6 to 0.8, 0.6 to 075, 0.7 to 0.9, 0.7 to less than 0.85, 0.7 to 0.8, 0.8 to 0.9, 0.5, 0.6, 0.7, 0.75, 0.78, 0.8, and 0.825.

In other embodiments, the palm ratio of the first palm-based fat to the second palm-based fat, by weight, may be from 50:50 to 85:15, greater than 50:50 and up to less than 85:15, 50:50 to 80:20, 55:45 to 75:25, 60:40 to 70:30, 50:50, 60:40, 70:30, and 80:20. In yet other embodiments, the palm ratio of the first palm-based fat to a sum of the second palm-based fat and any optional third palm-based fat, by weight, may be from 50:50 to 85:15, greater than 50:50 up to less than 85:15, 50:50 to 80:20, 55:45 to 75:25, 60:40 to 70:30, 50:50, 60:40, 70:30, and 80:20. In still further embodiments, the palm ratio of the second palm-based fat to a sum of the first palm-based fat and any optional third palm-based fat, by weight, may be from 50:50 to 85:15, greater than 50:50 up to less than 85:15, 50:50 to 80:20, 55:45 to 75:25, 60:40 to 70:30, 50:50, 60:40, 70:30, and 80:20.

The fat blends and compositions thereof may also include select ratios of the solid fat portion to liquid oil portion, which is called the fat-to-oil ratio. In various approaches, the fat-to-oil ratio, by weight, may be from 0.1 to 1.0, 0.2 to 0.8, 0.2 to 0.5, greater than 0.2 up to less than 0.75, 0.2 to 0.3, greater than 0.2 to less than 0.3, 0.25 to 0.75, 0.3 to 0.6, 0.3 to 0.65, 0.35 to 0.6, 0.4 to 0.75, 0.75, 0.72, 0.7, 0.22, 0.25, 0.27, 1.0 to 3.0, 1.0 to 2.0, 1.2 to 2.8, 1.25 to 2.7, 1.5 to 3.0. 1.8 to 2.6, 1.75 to 2.5, 2.0 to 3.0, 2.2 to 2.8, and 2.4 to 2.6.

To achieve the desired functionalities, the fats and compositions herein may also include, in some approaches, select palm fats combined with the aforementioned palm ratios and liquid oils. For example and in some embodiments and when two or more palm fats are combined, the first palm-based fat of the blend may have a solid fat content at 25° C. of at least 90% (in other approaches, about 90 to about 95%) and a solid fat content at 40° C. of at least 80% (in other approaches, about 80 to about 85%). In yet other approaches, the first palm-based fat may have a solid fat content at 25° C. of at least 95% and a solid fat content at 40° C. of at least 80%. The first palm-based fat may also have a solid fat content at 25° C. of at least 92% and a solid fat content at 40° C. of at least 81%. The first palm-based fat may have a solid fat content at 25° C. of at least 90%, a solid fat content at 30° C. of at least 85% and a solid fat content at 40° C. of at least 80%.

The first palm-based fat may also exhibit or have a composition so that it has a change in solid fat content of less titan 10% from 25° C. to 35° C. In other approaches, the first palm-based fat may have a change in solid fat content of less than 5% from 25° C. to 35° C., or the first palm-based fat may have a change in solid fat content of less than 2.5% from 25° C. to 35° C., In other approaches, the first palm-based fat may have a change in solid fat content from 2.5% to 10% from 25° C. to 35° C. With respect to temperature changes from 30 to 40° C., the first palm-based fat may have a change in solid fat content of less than 10%, In other approaches, the first palm-based fat may have a change in solid fat content of less than 5% from 30° C. to 40° C. The first palm-based fat may have a change in solid fat content of less than 2.5% from 30° C. to 40° C., The first palm-based fat may have a change in solid fat content front 2.5% to 10% from 30° C. to 40° C.

In some embodiments, the second palm-based fat in the blend may have a solid fat content at 25° C. of up to 70% (in other approaches, about 60 to about 70%) and a solid fat content at 40° C. of up to 5% (in other approaches, about 1 to about 5%). The second palm-based fat may have a solid fat content at 25° C. of less than 70% and a solid fat content at 40° C. of less than 5%. The second palm-based fat may have a solid fat content at 25° C. of up to 68% and a solid fat content at 40° C. of less than 3%. The second palm-based fat may have a solid fat content at 25° C. of less than 68% and a solid fat content at 40° C. of less than 1%. The second palm-based fat may have a solid fat content at 25° C. of up to 70%, a solid fat content at 30° C. of up to 30, and a solid fat content at 40° C. of up to 5%. The second palm-based fat may have a solid fat content at 25° C. of up to 68%, a solid fat content at 30° C. of up to 25, and a solid fat content at 40° C. of up to 3%, The second palm-based fat may have a solid fat content at 25° C. of less than 70%, a solid fat content at 30° C. of less than 25, and a solid fat content at 40° C. of less than 1%.

The second palm-based fat may also exhibit or have a composition effective so that it has a change in solid fat content of at least 80% from 25° C. to 35° C. The second palm-based fat may have a change in solid fat content of at least 75% from 25° C. to 35° C. The second palm-based fat may have a change in solid fat content of at least 50% from 25° C. to 35° C. The second palm-based fat may have a change in solid fat content from 50% to 75% from 25° C. to 35° C. The second palm-based fat may have a change in solid fat content of at least 20% from 30° C. to 40° C. The second palm-based fat may have a change in solid fat content from 10% to 20% from 30° C. to 35° C. The second palm-based fat may have a change in solid fat content of up to 10% from 35° C. to 40° C. The second palm-based fat may have a change in solid fat content of less than 5% from 35° C. to 40′C.

In various embodiments, the optional, third palm-based fat may have a solid fat content at 25° C. within 25%, 10%, or 5% of one of the first palm-based fat and second palm-based fat. In various embodiments, the third palm-based fat may have a solid fat content at 30° C. within 25%, 10%, or 5% of one of the first palm-based fat and second palm-based fat. In various embodiments, the third palm-based fat may have a solid fat content at 40° C. within 25%, 10%, or 5% of one of the first palm-based fat and second palm-based fat.

In various embodiments, the optional, third palm-based fat may have a change in the solid fat content within 25%, 10%, or 5% of one of the first pa]m-based fat and second palm-based fat from 25° C. to 35° C. in various embodiments, the third palm-based fat may have a change in the solid fat content within 25%, 10%, or 5% of one of the first palm-based fat and second palm-based fat from 30° C. to 35° C. In various embodiments, the third palm-based fat may have a change in the solid fat content within 25%, 10%, or 5% of one of the first palm-based fat and second palm-based fat from 30° C. to 40° C.

The overall fat blend (solid fat portion and liquid oil portion) and edible continuous aqueous emulsions or compositions incorporating the fat blends achieve the texture, sensory, and mouthfeel of compositions with higher fat levels through, among other features, the select blends of solid fats and oils, the solid fat contents of those fats and oils, and/or the methods of preparing the compositions. In other approaches, there may also be an associate between fat crystals and any starch base included in the composition and/or unique associations between the fat crystals and the liquid oil droplets in the compositions and emulsions.

The fats individually or within relationships outside of the ranges called for herein generally do not achieve the desired functionalities when incorporating lower levels of fats in the context of the compositions discussed herein. In the unique blends set forth above, the total solid fat fraction or blend (combination of solid fats and liquid oil, for example, palm fat(s)and soybean oil) may have a solid fat content at 25° C. of at least 80% and a solid fat content at 40° C. of at least 25%. The solid fat fraction may have a solid fat content at 25° C. from 80% to 90% and a solid fat content at 40° C. from 30% to 70%. The solid fat fraction may have a solid fat content at 25° C. of at least 80%, a solid fat content at 30° C. of at least 80%, a solid fat content at 35° C. from 35% to 75% and a solid fat content at 40′C from 30% to 70%. Referring to Tables 1 and 2 below, the overall fat blend andjor compositions including such blends may have a solid fat content (SFC) selected from the groups consisting of those shown in Tables 1 and 2:

TABLE 1

| Temperature, ° C. | SFC, % |
|---|---|
| 0 | 80-100 |
| 5 | 80-100 |
| 10 | 80-100 |
| 15 | 80-100 |
| 20 | 80-100 |
| 25 | 80-100 |
| 30 | 20-80 |
| 35 | 20-60 |
| 40 | 5-40 |

TABLE 2

| Temperature, ° C. | SFC, % | SFC, % | SFC, % | SFC, % | SFC, % |
|---|---|---|---|---|---|
| 10 | 95.22 | 93.60 | 51.67 | 53.00 | 86.34 |
| 20 | 94.50 | 83.90 | 30.09 | 26.97 | 71.83 |
| 25 | 92.48 | 72.38 | 20.47 | 16.39 | 62.39 |
| 30 | 89.46 | 24.81 | 13.13 | 9.29 | 48.93 |
| 35 | 85.90 | 2.79 | 7.95 | 4.70 | 35.78 |
| 40 | 80.70 | 0.10 | 5.02 | 1.10 | 26.83 |

Turning to more of the specifics, the unique fat fraction, in some approaches, may have a specific solid fat content that is relatively flat from 0 to 25° C. and, then, melts relatively quickly above 25° C. In other approaches, the solid fat fraction may have the profile as summarized in the exemplary fats of Table 3 below.

TABLE 3

| Temperature, ° C. | SFC, % | SFC, % | SFC, % | SFC, % | SFC, % |
|---|---|---|---|---|---|
| 10 | 95 | 93 | 51 | 53 | 86 |
| 20 | 94 | 83 | 30 | 26 | 71 |
| 25 | 92 | 72 | 20 | 16 | 62 |
| 30 | 89 | 24 | 13 | 9 | 48 |
| 35 | 85 | 3 | 7 | 4 | 35 |
| 40 | 80 | 0.1 | 5 | 1 | 26 |

In various embodiments, the fat blend or fraction may have a change in solid fat content of at least 45% from 25° C. to 35° C. The fat fraction may have a change in solid fat content of at least 40% from 25° C. to 35° C. The fat fraction may have a change in solid fat content of at least 35% from 25° C. to 35° C. The fat fraction may have a change in solid fat content of at least 30% from 25° C. to 35° C. The fat fraction may have a change in solid fat content of up to 50% from 25° C. to 35° C. The fat fraction may have a change in solid fat content of 15% to 50% from 25° C. to 35° C., The fat fraction may have a change in solid fat content of 25% to 45% from 25° C. to 35° C. The fat fraction may have a change in solid fat content of 30% to 40% from 25° C. to 35° C.

By one approach, the fat exhibits a solid fat content of about 80 to about 100 percent, in other approaches, about 85 to about 90 percent from about 0 to about 25° C. Above 25° C., the solid fat content is less than about 80 percent, in other approaches, less than about 65 percent, and in yet other approaches, is between about 80 percent and about 20 percent from about 30° C. to about 35° C. This solid fat content (either in a fat blend or when incorporated into the emulsions or compositions of this disclosure) provides a relatively flat profile from about 0 to about 25° C. and then drops off relatively rapidly above 25° C. so that the fat is relatively stable at both refrigerated and room temperatures but then melts rapidly in the mouth. This profile is advantageous because it provides a stable product at refrigerated and room temperatures so that the fat fraction and any dressing including the fat fraction is remarkably stable between the refrigerator and room temperature. In this manner, a consumer will not notice a difference with the product upon it being removed from the refrigerator.

Other exemplary solid fat contents of the unique fat fractions herein are provided in Tables 4 and 5 below. For purposes herein, the solid fat contents are those of the fat blends in an isolate or bulk oil, such as prior to incorporation into the products of this disclosure.

TABLE 4

| Temperature, ° C. | SFC 1, % | SFC 2, % |
|---|---|---|
| 0 | 80-100 | 85-90 |
| 5 | 80-100 | 85-90 |
| 10 | 80-100 | 85-90 |
| 15 | 80-100 | 85-90 |
| 20 | 80-100 | 85-90 |
| 25 | 80-100 | 85-90 |
| 30 | 20-80 | 40-80 |
| 35 | 20-60 | 30-60 |
| 40 | 5-40 | 20-40 |

TABLE 5

| Temperature, ° C. | SFC, % | SFC, % | SFC, % | SFC, % | SFC, % |
|---|---|---|---|---|---|
| 10 | 95 | 93 | 51 | 53 | 86 |
| 20 | 94 | 83 | 30 | 26 | 71 |
| 25 | 92 | 72 | 20 | 16 | 62 |
| 30 | 89 | 24 | 13 | 9 | 48 |
| 35 | 85 | 3 | 7 | 4 | 35 |
| 40 | 80 | 0.1 | 5 | 1 | 26 |

In some approaches, the solid fat portion of the fat blends used in the disclosure, such as palm fat, may have a fatty acid profile such that when the two solid fats are combined with the liquid oil in the relationships and ratios set forth herein, the unique functionalities are achieved. In various embodiments, for example, the first palm-based fat may comprise, by weight percent: up to about 1.5% lauric fatty acid (C12:0); at least about 75% myristic fatty acid (C14:0); and at least about 10% eladic acid (C18:1t). In other embodiments, the first palm-based fat may comprise, by weight percent, a balance of other fatty acids. In yet other embodiments, the first palm-based fat may be free of palmitic fatty acid (C16:0). In various embodiments, the first palm-based fat may be free of fatty acids having a carbon number of at least C20. In various embodiments, the first palm-based fat may comprise at least one fatty acid having a carbon number from C6 to C10. Referring to Table 6 below exemplary first palm-based fats may comprise, by weight percent:

TABLE 6

| Fatty Acid (%) | Range 1 | Range 2 |
|---|---|---|
| Lauric (C12:0) | up to 2 | 0.1 to 1.5 |
| Myristic (C14:0) | at least 75 | 75 to 85 |
| Eladic (18:1t) | at least 8 | 8 to 14 |

The fat blend may also include the second palm based fat. In some approaches, the second palm-based fat may comprise, by weight percent: up to about 0.5% lauric fatty acid (C12:0); up to about 1.0% myristic fa tty add (C14:01); and at least about 50% palmitic fatty acid (C16:0). In other approaches, the second palm-based fat may comprise, by weight percent, a balance of other fatty acids. In various embodiments, the second palm-based fat is free of fatty acids having a carbon number of up to C10. In still other embodiments, the second palm-based fat comprise at least one fatty acid having a carbon number of at least C22. Referring to Table 7 exemplary versions of the second palm-based fat may comprise, by weight percent:

TABLE 7

| Fatty Acid (%) | Range 1 | Range 2 |
|---|---|---|
| Lauric (C12:0) | up to 1 | 0.1 to 0.5 |
| Myristic (C14:0) | up to 1.0 | 0.1 to 1.0 |
| Palmitic (C16:0) | at least 50 | 50 to 60 |

In some approaches, the overall blend of fat (i.e., solid fat portion and liquid oil portion combined) suitable for lower fat continuous aqueous emulsions and compositions may include, in weight percent: the following fatty acid profiles. For example, up to about 1.0% lauric fatty acid (C12:0) (in other approaches, about 0.1 to about 1 percent); at least about 20% myristic fatty acid (C14:0) and in other approaches at least about 45% (in some cases, about 20 to about 28 percent myristic fatty acid, and in other approaches, about 40 to about 50 percent); at least about 5% palmitic fatty acid (C16:0) (in other approaches, about 5 to about 10 percent); at least about 10% linoleic fatty acid (C18:2c) in some approaches, and at least about 30% in other approaches, (in still other approaches, about 10 to about 17 percent linoleic fatty acid and, in other approaches, about 30 to about 35% linoleic fatty acid). in other embodiments, the solid fat fraction may comprise, by weight percent, a balance of other fatty acids. Referring to Table 8, in various embodiments, the solid fat fraction may comprise, in weight percent:

TABLE 8
Exemplary ranges of various fatty acids in overall fat blend

| Fatty Acid (%) | Range 1 | Range 2 | Range 3 | Range 4 |
|---|---|---|---|---|
| Lauric (C12:0) | up to 1.0 | 0.1 to 1.0 | 0.5 to 0.75 | 0.72 |
| Myristic (C14:0) | at least 20 | at least 45 | 20 to 30 | 40 to 50 |
| Palmitic (C16:0) | at least 5 | 5 to 10 | 9.5 | 8.5 |
| Linoleic (18:2c) | at least 10 | at least 30 | 10 to 17 | 30 to 35 |

As mentioned above, the dressings including the unique fat blend may be an editable, continuous aqueous composition may comprise an editable, continuous aqueous emulsion. The editable, continuous aqueous emulsion may comprise a spoonable pourable, and/or spreadable dressing. The dressing may comprise a mayonnaise-type composition. The dressing may comprise a salad-type dressing. The dressing may include lower levels of total fat (as compared to counterpart full fat products) and include a portion of its fat as the solid fat fractions herein to achieve the drama tic improvements in texture, viscosity, yield stress, and storage modulus. As mentioned above, the solid fat fractions permit lower fat products to mimic their fuller fat counterparts. By one approach, a low fat spoonable dressing may include a total fat content from about 5 to about 9 percent and about 2.5 to about 7 percent of the formula being the solid fat herein with the remainder of the fat being liquid oil, such as, soy bean oil. In other words, a spoonable dressing may include about 35 to about 75 percent of its total fat being the unique solid fat fractions herein. Thus, an about 5 percent total fat spoonable dressing (including 2.5 percent of the solid fat fraction herein) can mimic a higher fat product with about 9 percent total fat. In another example, an about 9 percent total fat spoonable dressing (including about 6.5 percent of the solid fat fraction herein) can mimic a higher fat product with about 22 percent total fat. In another approach, a pourable dressing may have a total fat of about 5 to about 15 percent with about 2 to about 7 percent being the solid fat fraction herein. This unique pourable dressing can mimic the texture of a full fat product having upwards of about 38 percent fat.

In one approach, exemplary formulas for spoonable and pourable dressings can be found in Tables 9 and 10, respectively.

TABLES 9 and 10

| | | |
|---|---|---|
| Ingredient | Amount, % | Range, % |

Exemplary Spoonable Dressing

| | | |
|---|---|---|
| Water | 68 | 50-75 |
| Sweetener | 6.5 | 0-10 |
| Soybean Oil | 3 | 0-12 |
| Solid Fat Fraction | 7 | 3-15 |
| Salted Egg yolk | 2 | 0-4 |
| Stabilizer Blend | 6 | 4-8 |
| Salt | 2 | 1-3 |
| Flavor/spice | 0.3 | 0-1 |
| Acids | 6.5 | 5-8 |

Exemplary Pourable Dressing

| | | |
|---|---|---|
| Water | 50 | 30-70 |
| Salt | 2 | 1-3 |
| Sugar | 2 | 1-2 |
| Stabilizer | 3.5 | 2.5-4.5 |
| Favor/spice | 2.5 | 1-5 |
| Egg yolk | 3 | 0-5 |
| Corn syrup | 20 | 5-25 |
| Soybean oil | 8 | 0-12 |
| Solid Fat Fraction | 5 | 3-15 |
| Acids | 4 | 2-6 |

In some approaches, one unexpected feature of using the fat fractions herein in the spoonable and pourable dressings is that the fat fractions may form segregated crystals of about 3 to about 70 microns in size in the continuous phase of the dressing or composition. The crystals are segregated or separated from the oil droplets therein. It was unexpected that such large crystals in a dressing would achieve the dramatic changes in texture. For example, conventional thinking holds that developing smaller particles (i.e., typically emulsified liquid oil droplets) would result in the greatest increased in product viscosity and yield. However, with the case of the fat fractions herein, large fat crystals, contrary to conventional wisdom, actually developed increases in yield, viscosity, and texture as set forth herein. These effects were observed at the relatively low levels of inclusion in the formulas described above. These effects are demonstrated in Appendices A and B. Thus, the spoonable and pourable dressings herein contain a blend of emulsified droplets of liquid oil and segregated or separated therefrom sold fat crystals.

In some approaches, the dressings herein may not include or are substantially free of gums, excessive starches, and other hydrocolloids. As used herein, does not include or substantially free of generally means less than about 1, percent, in some approaches, less than about 0.5 percent, in other approaches, less than about 0.1 percent, and in yet other approaches, no gums, starches, other hydrocolloids, and combinations thereof. In other approaches, the use of the solid fat fractions permits the rheological gap to be closed without use of more texturizing agents, such as gums, starches, and hydrocolloids. In some approaches, the dressings herein may include a ratio of texturizing agent to solid fat fraction of about 2.2 and a ratio of texturizing agent to total fat of about 0.6, and in other approaches, the dressings herein may include a ratio of texturizing agent to solid fat fraction of about 0.6 and a ratio of texturizing agent to total fat of 0.2. It will be appreciated, however, that these ratios are only exemplary and may vary.

In some approaches, the dressings and edible continuous aqueous emulsions and compositions may also include a starch base in addition to the unique fat blend. By one approach, the compositions may include about 1 to about 10 percent starch, and in other approaches, about 2 to about 7 percent starch. Exemplary starches include modified corn starch, corn starch, tapioca, modified food starches and mixtures thereof. The starch may be part of the stabilizer blend. While not wishing to be limited by theory, it is believed in some approaches there is an association between the fat crystal and any starch base in the composition that help build texture and viscosity. It is believed this associate may be strengthened when the fat crystals are formed in situ or formed after all the ingredients are blended together.

The dressings and compositions may comprise, based on weight percent, up to 20 of the fat blends or fraction as generally described herein. In the dressing, the fat blend or fraction may comprise, based on weight percent, from 1 to 20, 2.5 to 15, 5 to 13, 9 to 13, 5 to 9, 2.5, 5, 9, and 13 percent of the blend. The fat fraction may comprise a fat-to-oil ratio of the blend of solid-based fats to liquid oil, by weight, from 0.1 to 1.0 and 0.2 to 0.5. The fat fraction may comprise a fat-to-oil ratio of the blend of solid-based fats to soybean oil, by weight, from 1.0 to 3.0, 1.5 to 3.0, and 1.8 to 2.6, If palm oils are included, the fat fraction may also include a palm ratio of the first palm-based fat to second palm-based fat from 0.8 to 0.9. The dressing may comprise a total fat content, based on weight percent, up to 20, such as 1 to 20, 5 to 15, 5 to 9, 9 to 15, 5, 7, and 9. The total fat content may comprise the fat fraction, based on weight percent, up to 75, up to 70, up to 65, up to 60, up to 55, up to 50, 35 to 75, 40 to 70, 45 to 65, and 50.

In various embodiments, the dressing may be characterized by one or more of a texture, viscosity, yield stress and storage modulus similar within 25%), mostly similar (within 20%), and substantially similar (within 10%) to a corresponding dressing or composition (i.e., a counterpart dressing) lacking the solid fat fraction and having at least 44 weight percent more total fat content, such as 44 to 65 weight percent more total fat content, 50 to 60 weight percent more total fat content, and 55 weight percent more total fat content. The counterpart dressing may also include higher levels of gums, starches, and other hydrocolloids in some approaches. In various embodiments, the dressing may be characterized by a change in viscosity from a shear rate of 1×10⁻³ to 1×10³ (1/s) substantially similar to a corresponding dressing lacking the solid fat fraction and having at least 44 weight percent more total fat content, such as 44 to 65 weight percent more total fat content, 50 to 60 weight percent more total fat content, and 55 weight percent more total fat content. In various embodiments, the dressing may be characterized by a change in strain (%) over 400 seconds substantially similar to a corresponding dressing lacking the solid fat fraction and having at least 44 weight percent more total fat content, such as 44 to 65 weight percent more total fat content, 50 to 60 weight percent more total fat content, and 55 weight percent more total fat content, in various embodiments, the dressing may be characterized by a change in storage modulus (Pa) from 20° C. to 40° C. substantially similar to a corresponding dressing lacking the solid fat fraction and having at least 44 weight percent more total fat content, such as 44 to 65 weight percent more total fat content, 50 to 60 weight percent more total fat content, and 55 weight percent more total fat content.

In various embodiments, the dressing may be characterized by a cold firmness from 320 Pa to 340 Pa at 5° C. to 10° C. In various embodiments, the dressing may be characterized by a hot firmness from 400 Pa to 420 Pa at 20° C. to 25° C. In various embodiments, the dressing may be characterized by a change from cold firmness to hot firmness in 5 minutes or less when the dressing is heated at room temperature (21° C.). In various embodiments, the dressing may be characterized by a change from hot firmness to cold firmness in 30 minutes or less when the dressing is cooled at a temperature at refrigeration temperature (from 1.7° C. to 3.3° C.). In various embodiments, the dressing may have a viscosity of less than 100,000 Pas,

In various embodiments, the dressing may solid fat crystals formed in situ. The solid fat crystals may be separated from liquid oil droplets in a continuous phase of the dressing. The solid fat crystals may have a crystal size from about 4 micrometers to about 70 micrometers. The solid fat crystals may have a crystal size from 10 to 60 micrometers, 25 to 50 micrometers, 4 to 25, 10 to 20 micrometers, 25 to 70 micrometers, 30 to 60 micrometers and 35 to 45 micrometers. The solid fat crystals may have a uniform crystal size distribution. The solid fat: crystals may have a coefficient of variation of the crystal size distribution is 0.05 to 0.25.

In other approaches, the solid fat fractions herein may have at least a portion thereof crystallized with crystal sizes ranging from about 3 to about 70 microns. The solid fat fraction may also include a portion that is crystallized or, in some cases pre-crystallized prior to incorporation into the dressing. By one approach, the fat fractions may include crystals ranging in size from about 3 to about 70 microns. In other approaches, the solid fat is up to about 100 percent crystallized.

In various embodiments, the dressing may comprise at least one of water, oil, spices, salt, sweetener, vinegar, and combinations thereof. In various embodiments, the dressing may be free from gums, starches, and other hydrocolloids. In various embodiments, the dressing may comprise one of a salad dressing and mayonnaise.

The solid fat fractions herein may be made may a number of methods. In one approach, the methods are selected in order to pre-crystallize at least portions of the fat fractions prior to incorporating them into the dressings. In another approach, the solid fat fraction may first be melted, optionally blended with liquid oils, incorporated into a dressing, and then allowed to crystallize. In other forms, the solid fat fractions may be milled or micro-milled.

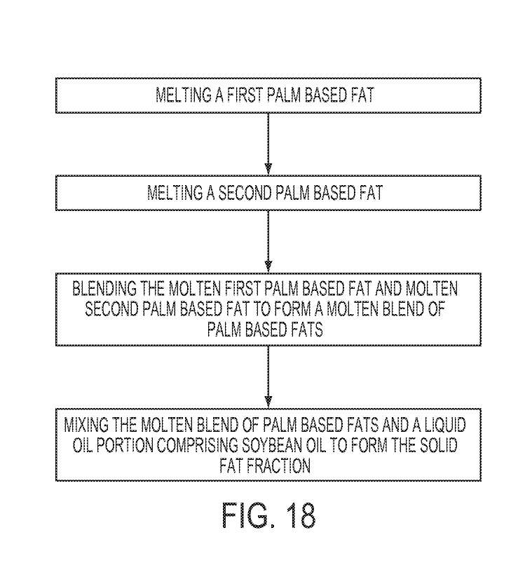

In various embodiments, turning to FIG. 18 for the moment, a method of making a solid fat fraction for a dressing may generally comprise melting a solid fat, such as in one exemplary approach, a first palm-based fat and a second palm-based fat, wherein the first palm-based fat has a solid fat content greater than the second palm-based fat at 25° C. and 40° C.; blending the molten first palm-based fat and molten second palm-based fat to form a molten blend of palm-based fats (if two or more solid fats are used), wherein a ratio of the first palm-based fat to the second palm-based fat, by weight, is from 0.5 to 0.7 (if two or more solid fats are used); and mixing the molten fats and a liquid oil portion (such as soybean oil and the like), wherein a ratio of the of solid-based fat(s) to the liquid oil, by weight, is from 0.1 to 3.0. In various embodiments, the fat fraction may comprise a ratio of the blend of palm-based fats to soybean oil, by weight, from 0.1 to 1.0 and 0.2 to 0.5, In various embodiments, the fat fraction may comprise a ratio of the blend of palm-based fats to soybean oil, by weight, from 1.0 to 3.0, 1.5 to 3.0, and 1.8 to 2.6. In various embodiments, the fat fraction may comprise a ratio of the first palm-based fat to the blend of palm-based fats, by weight, from 0.8 to 0.9.

In various embodiments, the method of making a fat fraction for a dressing may comprise adding the solid fat portion to at least one of water, oil, spices, salt, sweetener, vinegar, and combinations thereof to form the dressing. The dressing may be free from excessive gums, starches, and other hydrocolloids. The dressing may comprise a salad-type dressing or mayonnaise-type dressing.

In various embodiments, the method of making a solid fat fraction for a dressing may comprise crystallizing at least a portion of the solid fat fraction in situ to form solid fat crystals after other dressing ingredients are blended together. The solid fat crystals may have a crystal size from about 4 micrometers to about 70 micrometers. The solid fat crystals may be separated from liquid oil droplets in a continuous phase of the dressing. The solid fat crystals may have a uniform crystal size distribution. To this end, the solid fat crystals may have a coefficient of variation of the crystal size distribution from about 0.05 to about 0.25.

In various embodiments, the method of making a dressing may generally comprise mixing a starch base and a premix under shear in an emulsification device, such as a high shear short time (HSST) homogenizer. The method may comprise melting the solid fat fraction and injecting the molten solid fat fraction (e.g., as a hot stream) directly into the HSST homogenizer. The palm or other solid fat may crystallize in the dressing.

In various embodiments, a method of making a fat fraction comprising a solid fat portion and a liquid fat portion may also generally comprise blending at least one palm fat to form the solid fat portion, melting the solid fat portion, and mixing the melted solid fat portion and liquid fat portion, in other approaches, the emulsion is characterized by one or more of a texture, viscosity, yield stress and storage modulus substantially matching that of the same composition except lacking the fat fraction and having at least about 100 weight percent more total fat content. In some cases, the emulsion is characterized by a viscosity (Pa·s) within about +/−10 percent as compared to the same composition except lacking the solid fat fraction and having at least about 100 weight percent more total fat content. In other cases, the emulsion is characterized by a strain (%) within about +/−10 percent as compared to the same composition except lacking the solid fat fraction and having at least about 100 weight percent more total fat content. In yet other approaches, the emulsion is characterized by a storage modulus (Pa) within about +/−10% as compared to the same composition except lacking the solid fat fraction and having at least about 100% weight percent more total fat content. The emulsion may have a cold firmness from about 320 Pa to about 340 Pa at about 5′C to about 10° C. and a hot firmness from about 400 Pa to about 420 Pa at about 20° C. to about 25° C. in some approaches, the cold firmness to the hot firmness may change in about 5 minutes or less when the composition is at room temperature of about 20° C. to about 25° C. In yet other approaches, the emulsion may be characterized by a change from the hot firmness to the cold firmness in about 30 minutes or less when the composition is cooled at refrigeration temperatures from about 1° C. to about 4° C.

Advantages and embodiments of the solid fat fractions described herein are further illustrated by the following examples; however, the particular conditions, processing schemes, materials, and amounts thereof recited in these examples, as well as other conditions and details, should not be construed to unduly limit this method.

### EXAMPLES

### Example 1

In this Example, blends of two palm oils and soybean oil were blended to form a fat blend. The fat was then used in a continuous aqueous emulsion to form a salad-like dressing. Table 11 below is a design study showing various ratios of the two palm oils and various ratios of the total palm to soybean oil. Samples 8 and 9 were control samples with 100 percent soybean oil at either 9% total fat or 22 percent total fat. The tested samples include compositions of dressings comprising solid fat fractions as generally described herein (compositions 1, 5, and 6) and less desired or comparative compositions (compositions 2-4 and 7-9). In this Example, the fat was prepared by a blend of two palm fats and soybean oil. The first palm-based fat commercially available from IOI Loders Croklaan Americas. The second Palm-based fat is commercially available from IOI Loders Croklaan Americas. The soybean oil is commercially available from Bunge.

TABLE 11
Design Study

| | | First | Second | | | |
|---|---|---|---|---|---|---|
| | | palm | palm | Soybean | Total | Total |
| Sample | Starch | oil | oil | oil | palm | Fat |
| 1 | 5.7 | 2.275 | 0.975 | 1.25 | 3.25 | 4.5 |
| 2 | 5.6 | 2.372 | 0.419 | 1.71 | 2.79 | 4.5 |
| 3 | 5.6 | 2.482 | 0.438 | 1.58 | 2.92 | 4.5 |
| 4 | 5.7 | 3.25 | 0 | 5.75 | 3.25 | 9 |
| 5 | 5.9 | 2.083 | 0.368 | 6.55 | 2.45 | 9 |
| 6 | 5.6 | 1.743 | 0.308 | 6.95 | 2.05 | 9 |
| 7 | 5.6 | 2.05 | 0 | 6.95 | 2.05 | 9 |
| 8 | 5.7 | 0 | 0 | 9.0 | 0 | 9 |
| 9 | 5.3 | 0 | 0 | 22.0 | 0 | 22 |

### Example 2

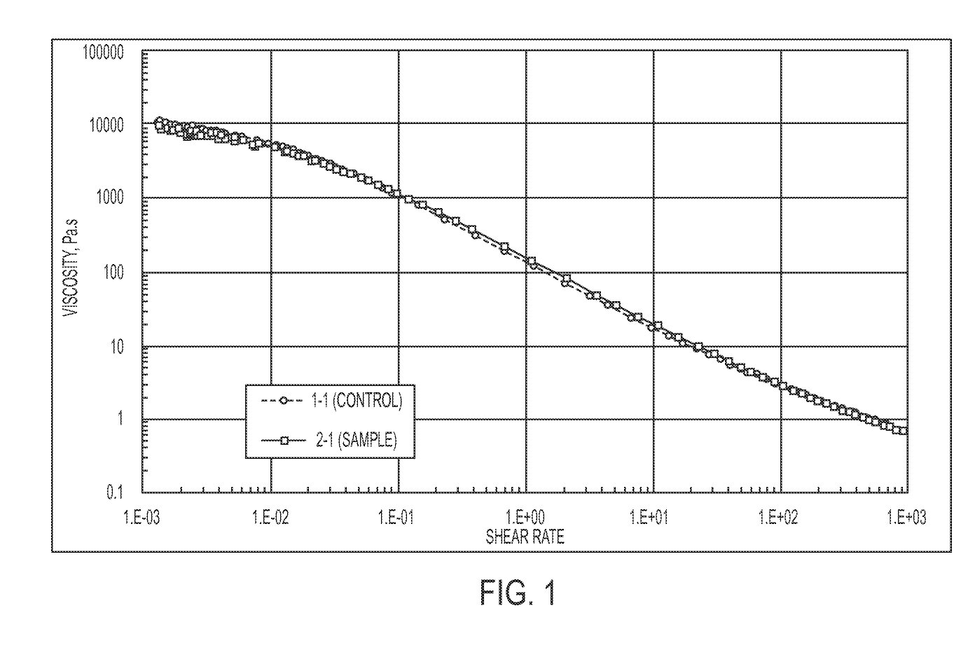

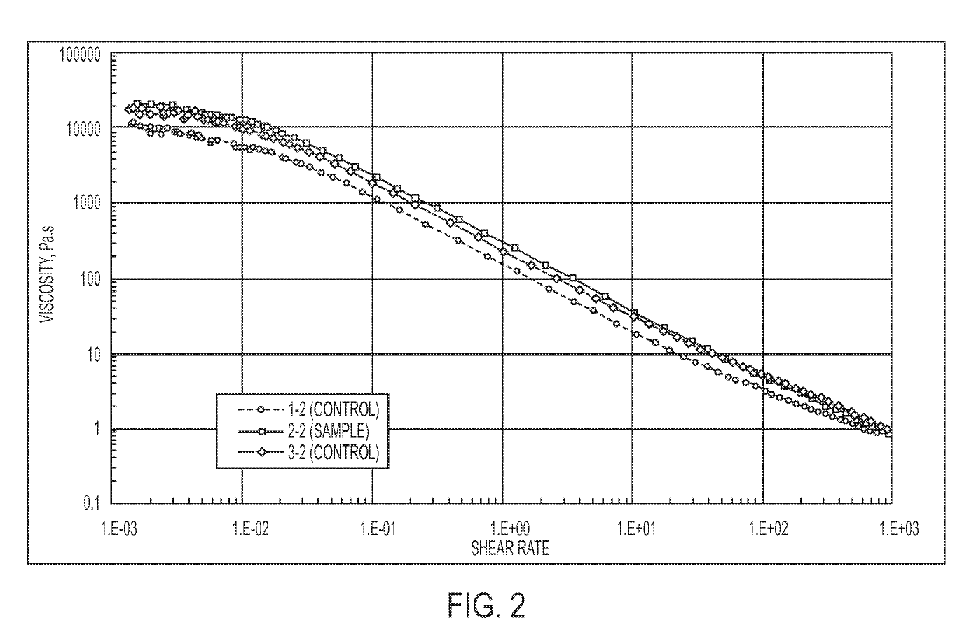

A study was completed comparing the viscosity characteristics of lower fat compositions consistent with the present disclosure to higher fat counterparts. FIGS. 1 and 2 include graphs of viscosity (Pa) versus shear rate (1/s) for dressings including a solid fat fraction as generally described herein (compositions 2-1. and 2-2) and comparative compositions (compositions 1-1, 1-2, and 3-2).

FIG. 1 shows that a lower fat dressing or composition (identified as Composition 2-1) having a total fat content of 5 weight percent (including 2.5 wt. % palm oil and 2.5 wt. % soybean oil) has a similar rheology relative to a higher fat dressing or composition (identified as Composition 1-1) comprising a total fat content of 9 weight percent (including 9 wt. % soybean oil and lacking palm oil).

FIG. 2 shows a low fat dressing (identified as composition 2-2) having a total fat content of 9 weight percent (including 6.5 wt. % palm oil and 2.5 wt. % soybean oil) having a similar rheology relative to higher fat dressings (identified as Compositions 1-2 and 3-2) comprising a total fat content of 22 weight percent (including 22 w(.% soybean oil and lacking palm oil). Both of compositions 2-1 and 2-2 exhibited segregated palm crystals separated from the liquid droplets of soybean oil. Without wishing to be bound to any particular theory, it is believed that the solid fat content of the fractionated palm oil as a function of temperature may modulate the rheology of the dressing to achieve a texture similar to dressing having higher fat contents.

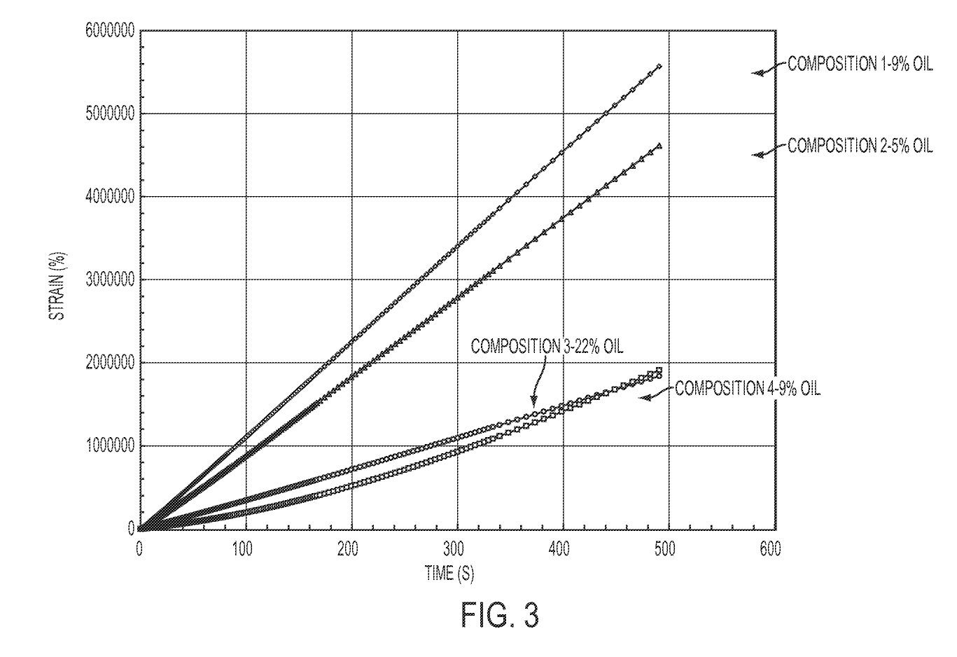

FIG. 3 includes a graph of strain (%) versus time (s) for dressings including the solid fat fraction as generally described herein (compositions 2 and 4 of this figure) and comparative compositions (compositions 1 and 3 of this figure). For example, FIG. 3 shows a dressing (composition 2) having a total fat content of 5 weight percent (including 2.5 wt. % palm oil and 2.5 wt. % soybean oil having a similar change in strain (%) over time relative to a dressing (composition 1) comprising a total fat content of 9 weight percent (including 9 wt. % soybean oil and lacking palm oil). FIG. 3 also shows a dressing (composition 4) having a total fat content of 9 weight percent (including 6.5 wt. % palm oil and 2.5 wt. % soybean oil) having a similar change in strain (%) over time relative to a dressing (composition 3) comprising total fat content of 22 weight percent, including 22 wt. % soybean oil and lacking palm oil). FIG. 3 shows that compositions 1 and 2 have similar resistance to deformation and compositions 3 and 4 have similar resistance to deformation.

### Example 3

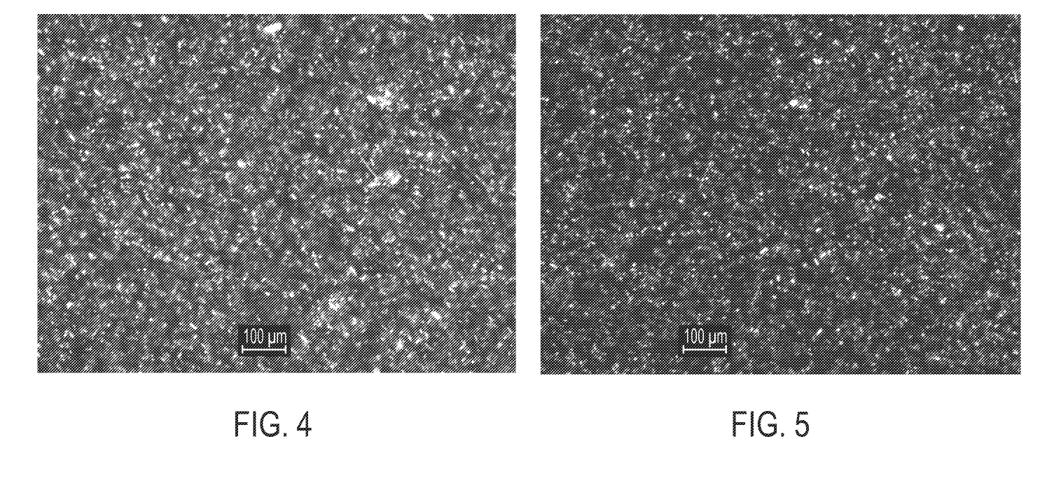

FIGS. 4 and 5 include microscope images of dressings according to various embodiments described herein formulated with 1% salted egg yolk (FIG. 4) and 0.5% whole egg and 0.5% egg yolk powder (FIG. 5). FIGS. 4 and 5 show that solid fat crystals exist as segregated fat from the liquid oil. Without wishing to be bound to any particular theory, it is believed that crystal size may relate to yield stress. While not wishing to be limited by theory, it is believed that the fat crystal strength the starch network by providing additional networks junctions. The number of additional network junctions will be proportional to number density of the crystals. The number density of the crystals will decrease with increasing crystal size that may also reduce the yield stress. Each dressing included about 6.5 weight percent palm oil and about 2.5 weight percent soybean oil. The dressing formulated with the salted egg yolk exhibited larger crystals relative to the dressing formulated with the whole egg. The dressing formulated with the salted egg yolk also exhibited a higher Haake yield stress of 332 relative to a Haake yield stress of 153 for the dressing formulated with the whole egg. Yield stress is the minimum stress required to make a fluid flow. Below the yield stress, the material resists flow. Yield stress is measured using, or example, a Haake VT-55-viscometer or equivalent.

### Example 4

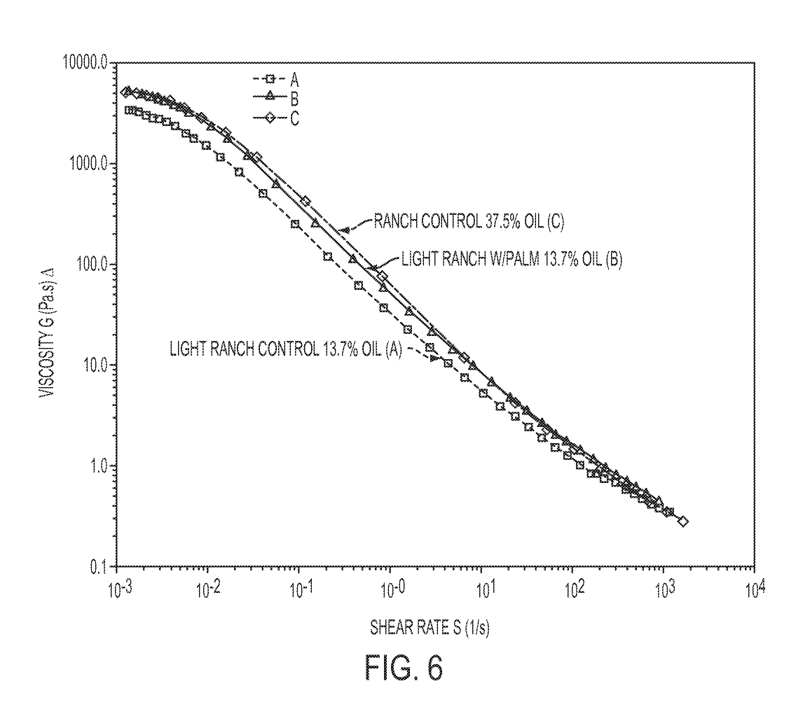

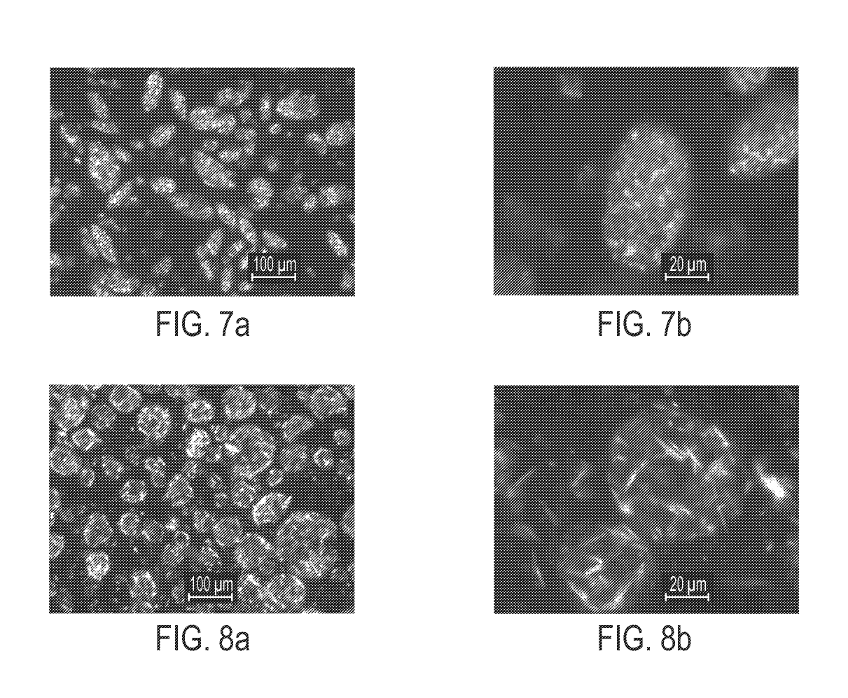

FIG. 6 includes a graph of viscosity C (Pa) versus shear rate (1/s) for a pourable dressing or pourable continuous aqueous composition including the solid fat fraction as generally described herein and comparative compositions. In this figure, the compositions are identified as Ranch Control (Sample C), Light Ranch w/Palm 13.7% oil (Sample B), and Light Ranch Control 13.7% Oil (Sample A), which included a total fat content of 37.5%, 13.7%, and 13.7%, respectively. Samples A and C included all soybean all and no palm fat. Sample B included a mixture of palm and soybean oil. Without wishing to be bound to any particular theory, it is believed that the mixture of palm fat and soybean oil in sample B modulates the rheology of the pourable dressing to achieve a texture similar to the higher fat control of sample C. Composition 2 also exhibited solid fat crystals comingled with liquid soybean oil in droplets, as shown in FIG. 7 and Sample A, with a similar fat level of 13.7%, but without the palm fraction, did not exhibit a viscosity consistent with the higher fat control.

FIGS. 7 and 8 include polarized light microscopy images of solid fat crystals in pourable dressing including a solid fat fraction comprising 100 weight percent palm-based fats and lacking soybean oil. FIGS. 7a and 8a show the solid fat crystals at lower magnification and FIGS. 7b and 8b show solid (at crystals at higher magnification.

### Example 5

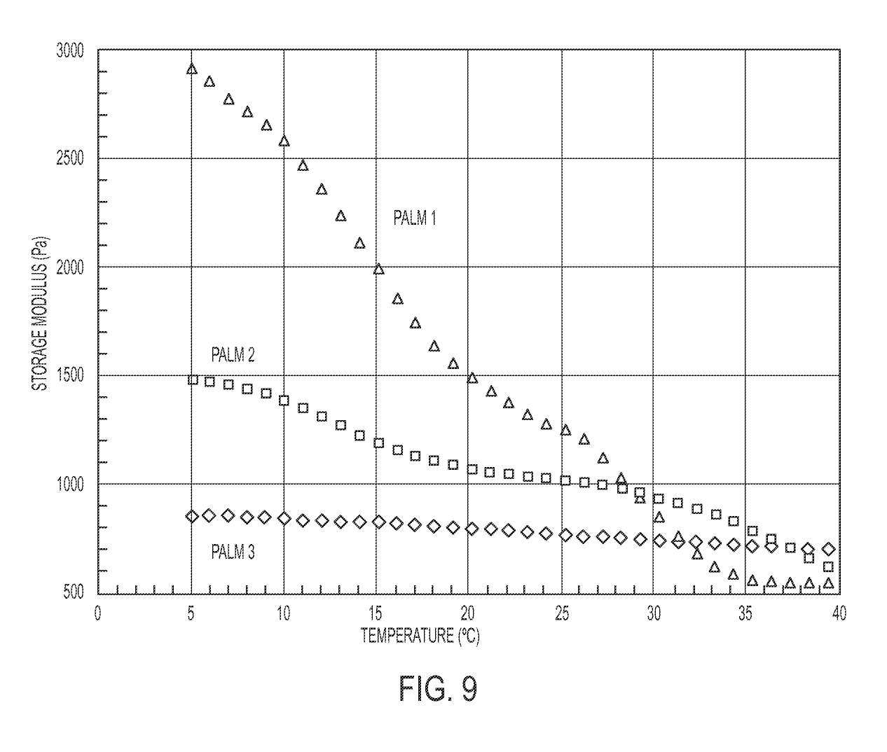

FIG. 9 includes a graph of firmness or shear modulus (Pa) v. temperature (° C.) for 3 compositions comprising a solid fat fraction comprising Palm (composition 1), a solid fat fraction (composition 2), and a solid fat fraction comprising a second palm (composition 3. The firmness of composition 1 changes from about 3000 Pa at 5° C. to about 1500 Pa at 20° C. to about 1000 Pa at 30° C. to about 500 Pa at 40° C. The firmness of composition 3 changes from about 850 Pa at 5° C. to about 700 Pa at 40° C. This shows that the solid fats that melts in the temperature range of about 5 to about 40° C. create highly temperature sensitive structures.

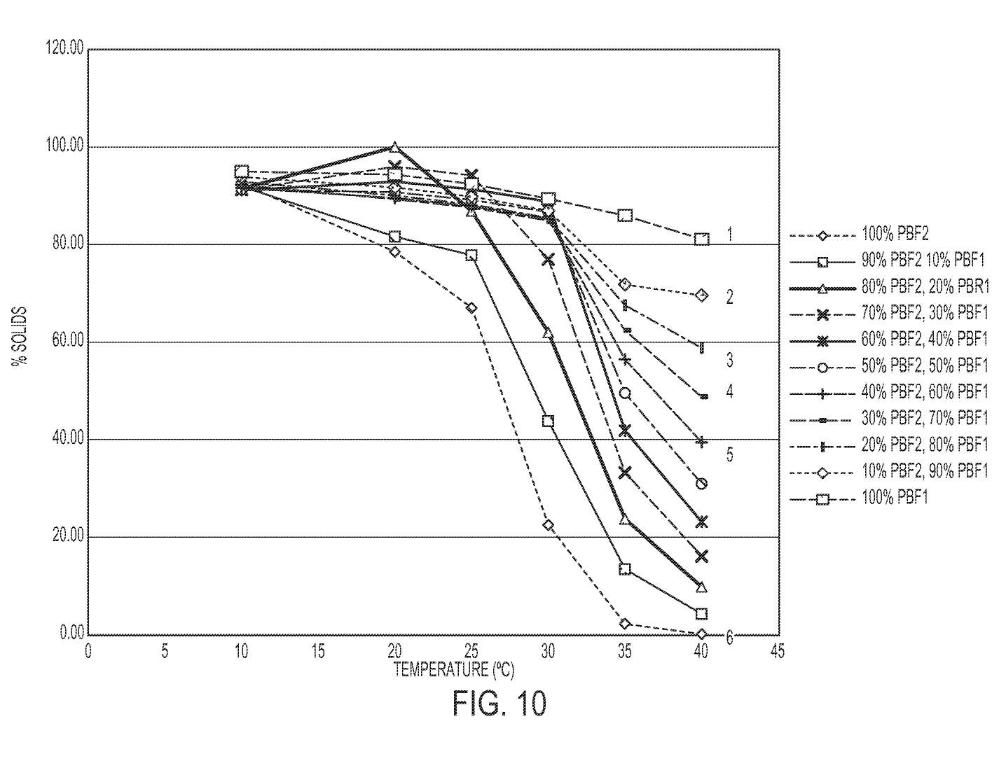

Some solid fat fractions may have a relatively steep melt at body temperature. For example, the solid fat fraction of the may have a change in solid fat content from 80-90% at 25° C. to 50-70% at 70° C., However, the steep melt may generate undesirable changes in texture as a function of temperature due to the variation of solid fat content between room temperature and refrigeration temperature. Other solid fat fractions may have a higher melting point and a less steep melt at body temperature. However, these solid fat fractions may form solid fat crystals detectable in tasting the dressing. As shown in FIG. 10, composition 1 has a solid fat content greater than compositions 2-5. The solid fat content of compositions 2-5 have the following relationship: composition 2>composition 3>composition 4 >composition 5. Composition 6 has a solid fat content less than compositions 1-4, Compositions 2 and 3 have a desirable texture and melt (change in solid fat content) at body temperature.

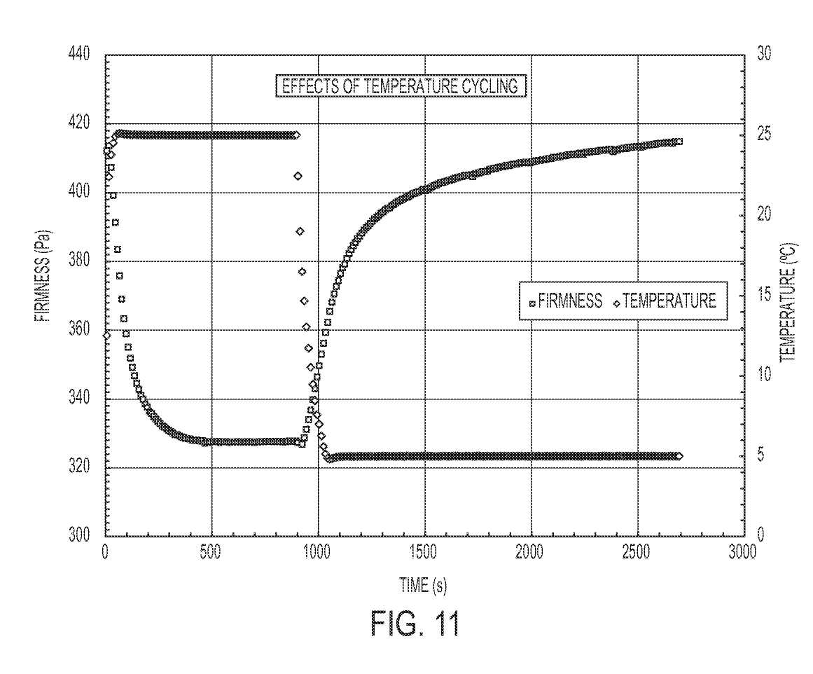

FIG. 11 shows the effect of temperature cycling on the texture of a dressing including exemplary solid fat fraction as described herein. The dressing has a cold firmness of 320 Pa to 340 Pa at 5° C. to 10° C. The dressing has a hot firmness of 400 Pa to 420 Pa at 20° C. to 25° C. The dressing changes from the cold firmness to hot firmness within 300 seconds after heating the refrigerated dressing at room temperature. The dressing changes from hot firmness to cold firmness within 1800 seconds when cooled to refrigeration temperature.

Equilibrium texture was attained within 5 minutes when the refrigerated dressing was heated to room temperature. Equilibrium texture was attained within 30 minutes when the dressing at room temperature was refrigerated. The firmness of the refrigerated dressing was equivalent to a corresponding dressing stored under refrigeration for 3 months. Equilibrium temperatures may be recovered by heating/cooling the dressing from 0° C. 60° C. Heating the dressing above 60 destroys the emulsion.

### Example 6

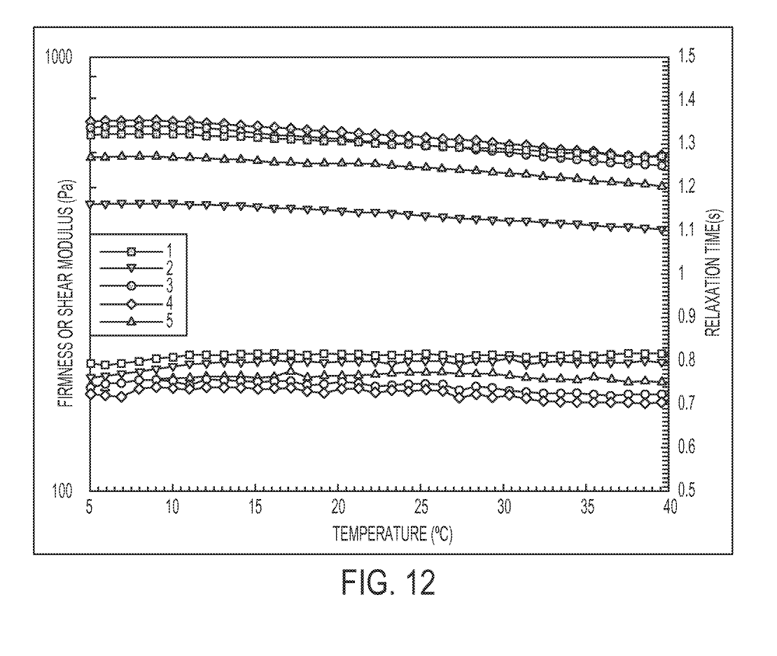

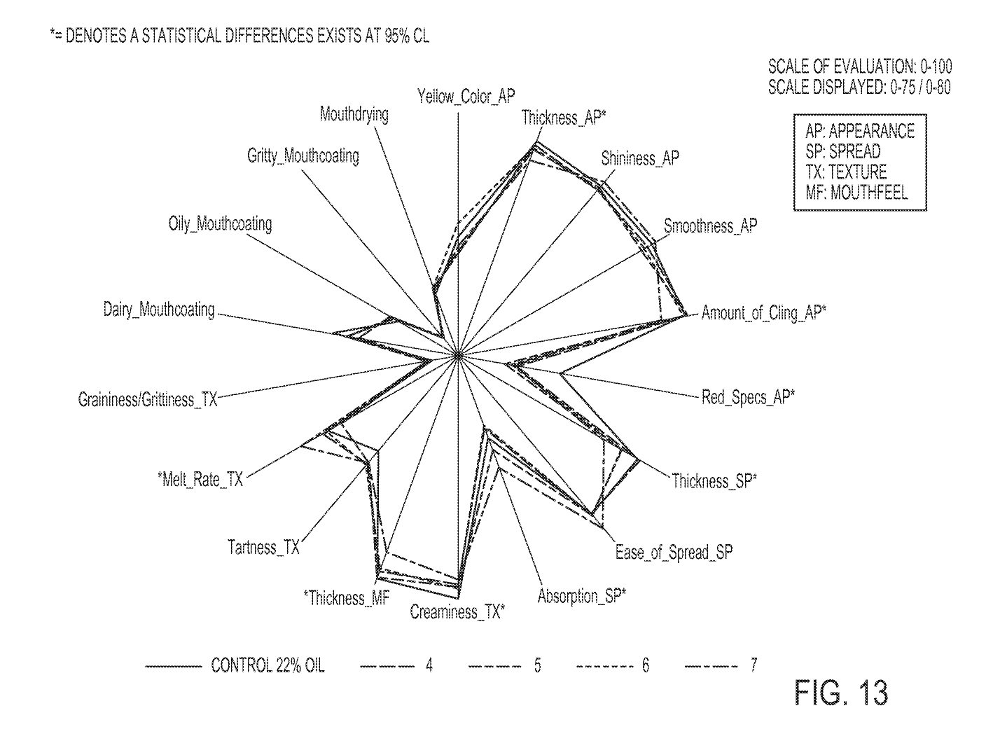

A study was completed to evaluate molten injection of palm fats into a mixer relative to a pre-mix of the fats and pre-crystallization. FIG. 12 includes a graph of firmness or shear modulus (Pa) and relaxation time (s) versus temperature (° C.) for 3 compositions comprising the a solid fat blend of palm and soybean oil as generally described herein (identified as compositions 3-5 in FIGS. 12) and 2 comparative compositions (identified as compositions 1 and 2 in FIG. 12).

Comparative composition 1 included 22 wt. % soybean oil and no palm oil in a spoonable, salad-type dressing. Composition 2 included 9 wt. % soybean oil and no palm-based oils in a spoonable, salad-type dressing. Each of these controls included water, soybean oil, spices, and gums added to a pre-mixture. The pre-mixture was then blended with other ingredients, such as flavors, additives, and a starch base to form the spoonable, salad-type dressing. Compositions 3-5 each included 5.75 wt. % soybean oil and 125 wt. % of a single palm oil. The soybean oil was included in the premix for compositions 1, 2, and 4. The palm oil was included in the premix for composition 5, while the single palm oil was melted and hot injected in to the mixer for compositions 3 and 4.

FIG. 12 shows that the firmness of compositions 3 and 4 is more similar to the firmness of composition 1 relative to composition 5. FIG. 12 also shows that the addition of 3.25 wt. % of the first palm-based oil to dressing having 9 wt. % total fat content (compositions 3-5) increased the firmness relative to composition 2. FIG. 12 shows that hot injection of a blend of the first palm-based oil and soybean oil is similar to hot injection of only the first palm-based oil.

As shown in the texture sensory profile, referring to FIG. 13, compositions 4, 5, and 6 had a texture that was not statistically different from composition 9, and composition 7 had a texture that was statistically different: from composition 9, Compositions 4, 5, and 6 were lower in red specs than composition 9 but generally had similar texture as composition 9. Composition 7 was lower in thickness appearance, red specs, thickness spread, creaminess texture, and thickness mouthfeel than composition 9.

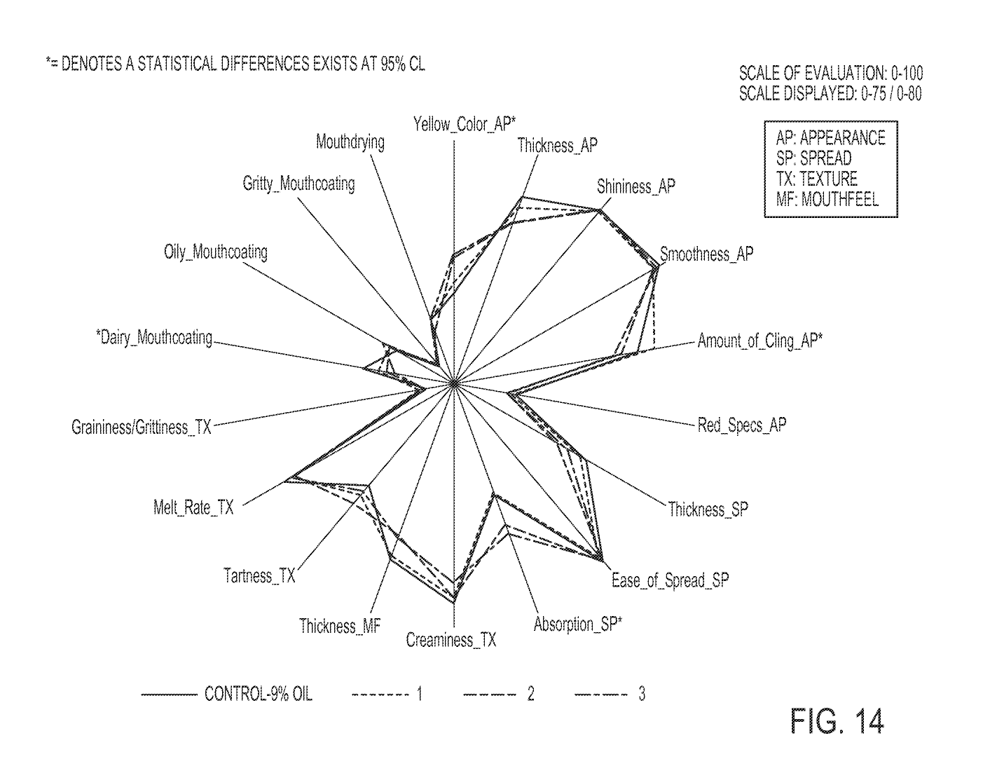

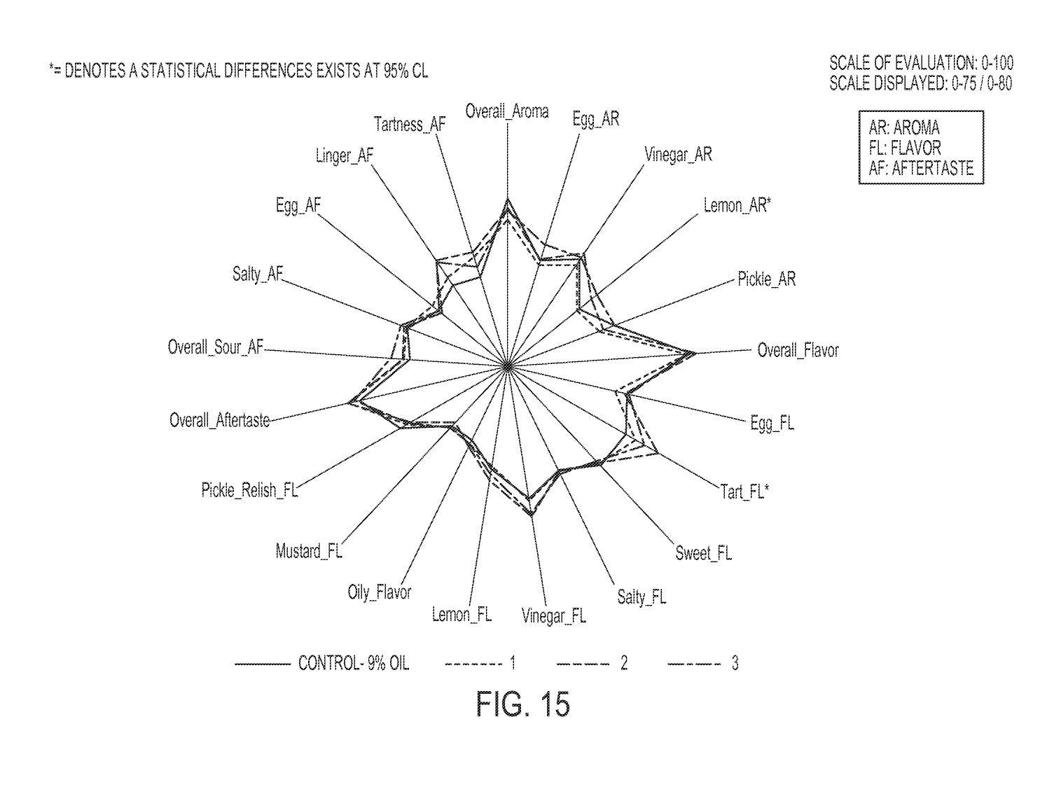

Referring to FIG. 14, as shown in the texture sensory profile, composition 1 had a texture that was not statistically different from composition 8 and compositions 3 had a texture that was statistically different from composition 8, Composition 2 was higher in yellow color than composition 8. Composition 3 was higher in yellow color and absorption, and lower in dairy mouthcoating than composition 9. As shown in the flavor sensory profile, referring to FIG. 15, compositions and 3 were not statistically different than composition 8, Composition 2 was higher in tart flavor than composition 8.

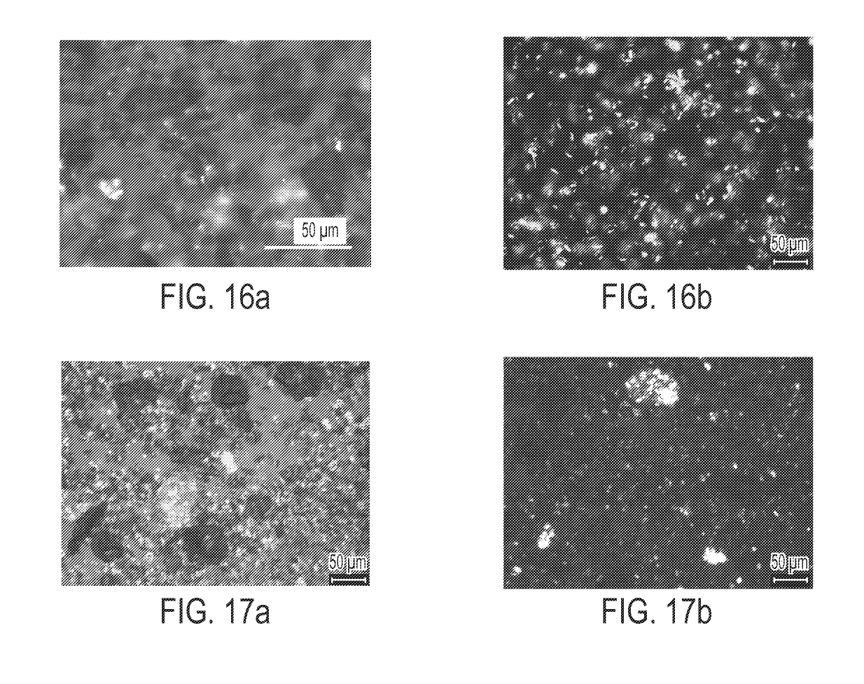

FIGS. 16 and 17 show images of dressings comprising 9 weight percent total fat and solid fat fractions having the same composition (3.25 weight present of the first palm-based oil and 5.75 weight percent of soybean oil) but processed according to 2 different methods. The first method included hot injecting the solid fat fraction into a shear device. The second method included adding the solid fat fraction to a pre-mix. Both methods form solid fat crystals. The first method forms the solid fat crystals in situ. The second method adds pre-crystallized solid fat to the mixer. As shown in FIGS. 16a and 16b, the first method forms a more uniform size distribution relative to the second method. Without wishing to be limited by theory, it is believed in the lower fat products described herein that the texture and the rheological gap is closed between the lower fat products and the higher fat products because the unique blends of fats form an associate between the liquid oil and a separated fat crystal and the starch base in the compositions. It is believed, that in some approaches, the in situ crystallization strengthens the structure of the starch base.

All numerical quantities stated herein are to be understood as being modified in all instances by the term “about” unless otherwise indicated. The numerical quantities disclosed herein are approximate and each numerical value is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, ranges of “1 to 10” and “between 1 and 10” are intended to include all sub-ranges between and including the recited minimum value of 1 and the recited maximum value of 10, Any maximum numerical limitation recited herein is intended to include all lower numerical limitations. Any minimum numerical limitation recited herein is intended to include all higher numerical limitations. As also used herein, free of or substantially free of a particular component or ingredient generally means less than about 1 percent, in other approaches, less than about 0.5 percent, and in other approaches, less than about 0.1 percent, and in still other approaches, none of the particular ingredient or component.

All percentages and ratios are calculated by weight unless otherwise indicated. All percentages and ratios are calculated based on the total weight of the compound or composition unless otherwise indicated. This disclosure describes various features, aspects, and advantages of various non-limiting embodiments of compositions and methods. It is understood, however, that this disclosure embraces numerous alternative embodiments that may be accomplished by combining any of the various features, aspects, and advantages of the various non-limiting embodiments described herein in any combination or sub-combination that one of ordinary skill in the art may find useful.

1. A fat blend configured for use in an aqueous continuous phase composition so that a lower fat composition can mimic the sensory and textural characteristics of a similar higher fat composition, the fat blend comprising:
a solid fat portion including a first palm-based fat and a second, different palm-based fat, wherein the first palm-based fat has a solid fat content greater than the second palm-based fat at about 25° C. and at about 40° C.;
a palm fat ratio of the first palm-based fat to the second palm-based fat, by weight, from about 0.5 to about 0.7;
a liquid oil portion including soybean oil; and
a fat-to-oil ratio of the palm-based fats to the soybean oil, by weight, from about 0.1 to about 3.0.

2. The fat blend of claim 1, wherein the fat-to-oil ratio is selected from one of 0.1 to 1.0; 0.2 to 0.5; 1.0 to 3.0; 1.5 to 3.0; and 1.8 to 2.6.

3. The fat blend of claim 1, wherein the first palm-based fat has a solid fat content at about 25° C. of at least about 90% and a solid fat content at about 40° C. of at least about 80% and wherein the second palm-based fat has a solid fat content at about 25° C. of up to about 70% and a solid fat content at about 40° C. of up to about 5%.

4. The fat blend of claim 1, wherein the first palm-based fat has a change in solid fat content of less than about 5% from about 25° C. to about 35° C. and the second palm-based fat has a change in solid fat content of at least about 50% from about 25° C. to about 35° C.

5. The fat blend of claim 1, further comprising a solid fat content at about 25° C. of at least about 80% and a solid fat content at about 40° C. of at least about 5% and having a change in solid fat content of at least about 25% from about 25° C. to about 35° C.

6. The fat blend of claim 1, wherein the fat blend has a solid fat content of about 80 to about 100% at about 0° C., about 80 to about 100% at about 5° C., about 80 to about 100% at about 10° C., about 80 to about 100% at about 15° C., about 80 to about 100% at about 20° C., about 80 to about 100% at about 25° C., about 20 to about 80% at about 30° C., about 20 to about 60% at about 35° C., and about 5 to about 40% at about 40° C.

7. The fat blend of claim 1, further comprising, in weight percent, up to about 1.0% lauric fatty acid (C12:0); at least about 20% myristic fatty acid (C14:0); at least about 5% palmitic fatty acid (C16:0); and at least about 10% linoleic fatty acid (C18:2c);

8. An edible, continuous aqueous emulsion configured to exhibit organoleptic characteristics of a higher fat edible, continuous aqueous emulsions, the emulsion comprising:
about 2.5 to about 15 weight percent of a fat blend including a solid fat portion and a liquid oil portion, the solid fat portion having a solid fat content at about 25° C. of at least about 80%, a solid fat content at about 40° C. of at least about 5%, and having a change in solid fat content of at least about 25% from about 25° C. to about 35° C.;
a ratio of the solid fat portion to the liquid oil portion, by weight, from about 0.1 to about 3.0;
a total fat content from about 4 to about 15 weight percent; and
wherein the composition exhibits organoleptic characteristics of a similar higher fat emulsion.

9. The emulsion of claim 8, wherein the fat-to-oil ratio is selected from one of 0.1 to 1.0; 0.2 to 0.5; 1.0 to 3.0; 1.5 to 3.0; and 1.8 to 2.6.

10. The emulsion of claim 8, further comprising a solid fat content of about 80 to about 100% at about 0° C., about 80 to about 100% at about 5° C., about 80 to about 100% at about 10° C., about 80 to about 100% at about 15° C., about 80 to about 100% at about 20° C., about 80 to about 100% at about 25° C., about 20 to about 80% at about 30° C., about 20 to about 60% at about 35° C., and about 5 to about 40% at about 40° C.

11. The emulsion of claim 8, further comprising, in weight percent, up to about 1.0% lauric fatty acid (C12:0); at least about 20% myristic fatty acid (C14:0); at least about 5% palmitic fatty acid (C16:0); and at least about 10% linoleic fatty acid (C18:2c);

12. The emulsion of claim 8, characterized by one or more of a texture, viscosity, yield stress and storage modulus substantially matching that of the same composition except lacking the fat fraction and having at least about 100 weight percent more total fat content.

13. The emulsion of claim 12, characterized by a viscosity (Pa·s) within about +/−10 percent as compared to the same composition except lacking the solid fat fraction and having at least about 100 weight percent more total fat content.

14. The emulsion of claim 12, characterized by a strain (%) within about +/−10 percent as compared to the same composition except lacking the solid fat fraction and having at least about 100 weight percent more total fat content.

15. The emulsion of claim 8, characterized by a storage modulus (Pa) within about +/−10% as compared to the same composition except lacking the solid fat fraction and having at least about 100% weight percent more total fat content.

16. The emulsion of claim 8, characterized by a cold firmness from about 320 Pa to about 340 Pa at about 5° C. to about 10° C. and a hot firmness from about 400 Pa to about 420 Pa at about 20° C. to about 25° C.

17. The emulsion of claim 16, characterized by a change from the cold firmness to the hot firmness in about 5 minutes or less when the composition is at room temperature of about 20° C. to about 25° C.

18. The emulsion of claim 16, characterized by a change from the hot firmness to the cold firmness in about 30 minutes or less when the composition is cooled at refrigeration temperatures from about 1° C. to about 4° C.

19. The emulsion of claim 8, further comprising solid fat crystals having an average crystal size from about 4 micrometers to about 70 micrometers.

20. The emulsion of claim 19, wherein the solid fat crystals are separate from liquid oil droplets in a continuous phase of the composition.

21. The emulsion of claim 20, wherein the solid fat crystals have a uniform crystal size distribution wherein a coefficient of variation of the crystal size distribution is about 0.05 to about 0.25.

22. The emulsion of claim 8, further comprising a viscosity of less than about 100,000 Pas.

23. The emulsion of claim 8, further comprising at least one of water, oil, spices, salt, sweetener, vinegar, and combinations thereof.

24. The emulsion of claim 8, further comprising about 1% or less of each of gums, starches, hydrocolloids, and combinations thereof.

25. The emulsion of claim 8, wherein the composition is a salad-type dressing.

26. A method of making an edible, continuous aqueous composition, the method comprising:
melting a solid fat to form a molten fat;
adding the molten fats and a liquid stream at a temperature below the molten fat where the liquid stream include a liquid oil portion, wherein a fat-to-oil ratio of the molten blend of palm-based fats to the soybean oil, by weight, is from about 0.1 to about 3.0; and
shearing the blended molten fat and liquid oil to form the edible, continuous aqueous composition.

27. The method of claim 26, wherein the fat-to-oil ratio is selected from one of 0.1 to 1.0; 0.2 to 0.5; 1.0 to 3.0; 1.5 to 3.0; and 1.8 to 2.6.

28. The method of claim 26, further comprising blending one of water, oil, spices, salt, sweetener, vinegar, and combinations thereof to form the composition.

29. The method of claim 26, further comprising crystallizing at least a portion of the solid fat fraction in situ to form solid fat crystals after the molten palm fats are added to the mixing device.

30. The method of claim 26, wherein the solid fat crystals have an average crystal size from about 4 micrometers to about 70 micrometers.

31. The method of claim 30, wherein the solid fat crystals are separated from liquid oil droplets in a continuous phase of the composition.

32. The method of claim 31, wherein the solid fat crystals have a uniform crystal size distribution with a coefficient of variation of the crystal size distribution from about 0.05 to about 0.25.

33. The method of claim 26, wherein the composition has about 1% or less of each of gums, starches, hydrocolloids, and combinations thereof.
